(19) United States
(12) Patent Application Publication
(10) Pub. No.: US 2009/0286559 A1
(43) Pub. Date: Nov. 19, 2009

(54) Method and system for communicating status in a service queue

(75) Inventors: Jonathan P. Janas, Cave Creek, AZ (US); Mark A. Thompson, Chandler, AZ (US)

Correspondence Address: MARVIN A. GLAZER, 2141 E. HIGHLAND AVE, SUITE 155, PHOENIX, AZ, 85016, US

(73) Assignee: W8TER, L.L.C.

(21) Appl. No.: 12/152,757

(22) Filed: May 15, 2008

(51) Int. Cl. H04Q 7/20

(52) U.S. Cl. 455/466

(57) ABSTRACT

A queuing system to notify customers of the status of requested service includes an input terminal operated by a service advisor. The service advisor communicates with each customer, and enters service parameters for customer service. The service advisor's input terminal is coupled by a computer network to a remote server which computes service completion data. The queuing system includes a display monitor coupled to the remote server by the computer network to display queue status in a customer waiting area. Notifications can also be sent via email or text message to a customer's mobile wireless device. Also disclosed is a method for informing customers of queue status that displays a service status on a display monitor in a waiting room, and which optionally transmits service status to a customer's mobile wireless device or networked computer.

### BACKGROUND OF THE INVENTION

1. Field of the Invention

The present invention relates to a system and method for allowing a service provider to keep customers apprised of the status of a service requested by the customer. More particularly, this invention relates to a system and method for informing such a customer that its request for service has been met.

2. Description of Related Art

Customers of service industries (repair shops, restaurants, hair salons, tailors, etc.) can often feel disconnected from a service provider. Service providers are also always trying to improve their customer service to ensure satisfied customers. Service providers often fail to communicate an expected service time, and/or any progress of the service, leaving customers with an uneasy feeling as to the expected completion time, and level of service being provided.

When the service involves repair or maintenance to a customer's personal property, the customer generally worries about when their property will be returned. By way of example only, this is often the case in most vehicle repair shops. Such repair shops require the use of a garage to service vehicles. Customers are asked to wait in a waiting room, or other location outside of the garage, to avoid the excessive noise, debris, safety hazards, or other environmental conditions that make it unpleasant for the customer to wait nearby. Such waiting rooms are often located out of view of the service garage, so waiting customers are unable to gauge the progress of the work being performed. The customer's uncertainty as to the status and progress of vehicle repair, coupled with the customer's reluctance to leave the service location, can often lead to customer frustration and dissatisfaction. In addition, customers are asked to remain on the premises or in a waiting room to allow the service representative to contact the customer regarding the service. Customers may feel as though they cannot leave the premises, to conduct their personal affairs, for fear of missing an important update, or causing an unnecessarily long delay before they can reclaim their property.

Some service providers attempt to update waiting customers as to the status and progress of the requested service, as well as an expected completion time. For example, a service representative might call a customer, or meet with the customer in a waiting area, to provide an estimate of completion time to the customer, either at the start of repair (hand-off) or sometime during the repair. However, such telephone calls/meetings use time that the service representative might more efficiently use to better serve other customers. Furthermore, service representatives typically need to be at the service location to facilitate such customer updates. Service representatives must continually monitor the service status and be cognizant of the customer's location.

In addition, service representatives, restaurant managers, and other employees who regularly interface with customers, sometimes take off-site lunch breaks, or otherwise leave the service location. During such instances, the service representative has difficulty monitoring the status of service requests or reacting to changed circumstances.

Therefore it is an object of the present invention to provide an automated service status update system and related method for keeping customers apprised of the status of the requested service.

It is a further object of the invention to provide such a system that provides customers with multiple options to receive service status updates.

It is another object of the present invention to provide such a system that allows customers to feel more at ease while waiting for the requested service to be completed.

A further object of the invention is to provide prompt notice to customers when the requested service is nearing completion.

It is still another object of the present invention to allow customers to roam from the service location while still allowing such customers to be notified when the requested service is available and/or updated and or/has been completed.

It is yet another object of the present invention to provide such a system that allows customers to make better use of their time while awaiting completion of the requested service.

It is still yet another object of the present invention to allow service providers to work with less interruption from impatient customers.

It is still yet a further object of the present invention to provide such a system that allows service personnel to leave the service location while still permitting such service personnel to remotely update status information.

It is another object of the invention to provide a method to automatically follow-up with customers to ensure their satisfaction, and to allow the service providers to obtain customer feedback.

These and other objects of the present invention will become more apparent to those skilled in the art as the present description proceeds.

### SUMMARY OF INVENTION

Briefly described, and in accordance with a preferred embodiment thereof, the present invention is a system to compute and relay service queue status to customers. A Service Advisor greets a customer and obtains customer service data from the customer. The Service Advisor then inputs this information into an input terminal, usually disposed at the service location. The input terminal is linked to a network allowing the terminal to connect to a server computer. The server receives customer service data, as well as information relating to the status of the service location's facilities. The server computes service completion status data, which preferably includes an estimated end of service time for each customer. Customer service data includes personal information relating to the customers, and service status data includes information as to the amount of time for service, and may also include types of service and projected end time for service. In a preferred embodiment, the customer can view this status information on a display monitor at a waiting room near the service station. The Service Advisor can provide updated information to the customer via the waiting room display monitor, or via a messaging system to notify the customer on a mobile telecommunications device. In another preferred embodiment, the server generates a message that is communicated to the customer over a cellular telephone network.

When it becomes necessary to update the service status data, either due to new service needs, delays, cancellations or the like, the Service Advisor can communicate updated service status data to the server. This information may be referred to as service update data. The server will then compute new expected service completion status data. This new data will also call for a new projected time for service, also referred to as a renewed service time. This information is automatically relayed to the display monitor for display in the waiting room, and can be relayed via text message to a mobile phone, PDA, or any other electronic device capable of information upload as known in the art today or as may become known in the art.

In the preferred embodiment, a trigger is set at a specified time prior to completion of service, such as twenty minutes prior to the computed service completion time, to provide a twenty minute warning. The warning is displayed at the waiting room display monitor and/or via the Service Advisor's mobile device. Such a warning provides the Service Advisor ample time to make any adjustments to the customer's service time, and thereby generate a customer notification update.

The computer network can be a public data information network, such as the Internet, to allow a relatively large number of independent service stations to share the same server. Access to the server via the Internet allows easier access to the server from many terminals. For instance, any computer, laptop, PDA, or mobile phone, that has an Internet connection could access service completion status data, or even input new or changed service requirements and customer service data. A cell phone capable of sending and receiving text messages, and having a graphic display, can serve as an input terminal. Access to the server is protected by a security protocol, such as a user login requirement.

Another aspect of the present invention relates to a method for communicating queue status to customers. In the preferred embodiment, the method generally includes the steps of inputting customer service data through an input terminal over a network to a server. The server then uses the data to compute service completion status data. The service completion status data is then relayed over the network to a display monitor near the service location for being viewed by a customer. If requested by a customer, the service completion status data can also be relayed via text messaging or other notification message to a customer's mobile communication device.

To ensure that the customer is properly apprised of the service status, further communications can also be conveyed to the customer, e.g., information as to how much time is left for service. Such additional information can be indicated on the display monitor, and such information can also be sent to a customer's mobile communications device.

Preferably, data displayed to customers includes a customer identifier (e.g. the customer's name), as well as information regarding the services to be performed. In the preferred embodiment of such method, users are allowed to login to the server over the Internet through various terminals, including, for example, a personal computer or mobile phone.

In the preferred embodiment, promotional messages are also displayed to users on the display monitor, on a user's mobile device, or on the user's computer when logging onto the server.

The method for communicating queue status preferably includes the ability to update service status. Any changes or additions to service requirements and or status can be sent to the server as updated information. These updates allow the server computer to recompute the expected service time, end time, and all related triggers. The updated service completion status data can then be relayed for display on the display monitor or sent out to a mobile telecommunications system as a text message or via email. The updates are viewable through any terminal that logs onto the server.

In the preferred embodiment of the above-described method, the projected end time is displayed on the display monitor. Triggers can be set to modify the display based on certain criteria, such as time until expected completion, and completion of service. Of course, these triggers can also cause update messages to be sent to a user's mobile communications device.

Another aspect of the aforementioned method includes the step of following up with customers. This follow-up can be achieved by sending a message to the customer sometime after the service is complete to obtain customer feedback. If the user initially requested that notifications be sent via mobile text message, then text messaging can be used to contact that customer for such feedback. Even if a customer did not initially request text messages, follow-up messages can still be sent via mobile communications, or any other method capable of facilitating feedback from the customer.

### BRIEF DESCRIPTION OF THE DRAWINGS

The present invention will be better understood from reading the following description of the preferred embodiments, with reference to the attached drawings, wherein:

FIG. 1 is a topographical view of a the service station in relation to various customer users according to a preferred embodiment of the invention.

FIG. 2 is a flowchart showing the data flow operation of a notification system according to a preferred embodiment of the invention.

FIG. 3 is a flowchart showing the logic for sending out messages and notifications to users via a display monitor or mobile alert.

FIG. 4 is a schematic diagram of the networked components that are used in constructing a preferred embodiment of the invention.

FIG. 5 is a flow chart indicating steps performed by the remote server for computing service completion status data.

FIG. 6 is a flow chart indicating steps performed by the remote server for computing service completion status data when an update occurs causing renewed service time calculation.

FIG. 7 is an example view of an image shown on the waiting room display monitor.

FIG. 8 is an example of a text message indication sent to a Service Advisor.

FIG. 9 is an example of an email message indication sent to a customer.

### DETAILED DESCRIPTION OF THE PREFERRED EMBODIMENT

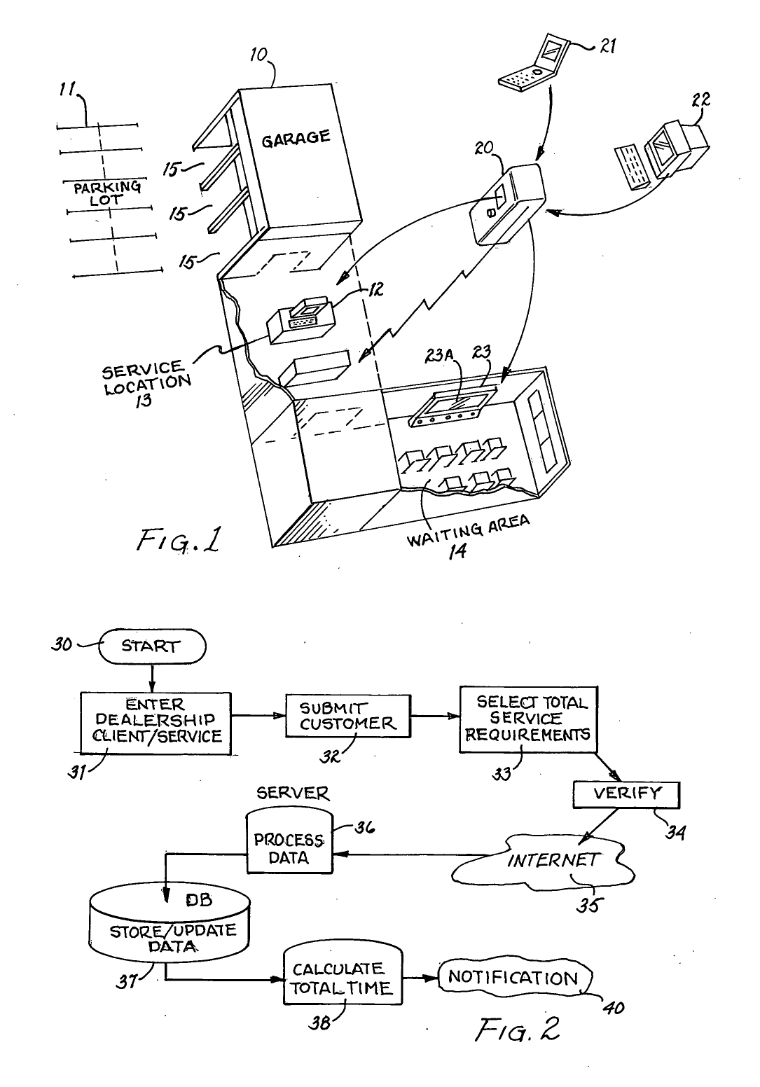

For the purposes of illustration, a preferred embodiment of the present invention is described in conjunction with an automobile repair service provider. The customer brings in a car for service and hands-off the vehicle to a Service Advisor. The Service Advisor initially meets with the customer to discuss required repairs and/or anticipated maintenance. Referring to FIG. 1, the service is provided at a set location 13. The service station includes a car service repair shop, or garage 10. However, in alternative embodiments, the service station may be any repair shop, restaurant, or any location where a service is performed and/or provided. For example, a crowded restaurant might make use of the invention to communicate with patrons who are waiting to be seated at a dining table.

After the Service Advisor meets with the customer, the car is then temporarily placed in a parking area 11 to wait until a service bay 15 is free, or is moved directly into a service bay 15 for more immediate service. Maintenance requirements and/or necessary repairs are established by service technicians. As shown in FIGS. 1 and 2, the Service Advisor responsible for the particular vehicle will collect customer and service information (at step 32), and input these initial parameters into an input terminal 12 located at service location 13 near garage 10. The input terminal may take the form of a personal computer coupled to a remote server computer via the Internet. The customer may wait in designated waiting area 14 at service location 13. Display monitor 23 is provided within waiting area 14. If a customer elects to wait in waiting area 14, the customer may continually update himself/herself as to the status and expected completion time of the vehicle service by viewing display monitor 23 located in waiting room 14. The display monitor is preferably a large-screen display that can be viewed throughout the entire waiting room. While display monitor 23 is normally disposed in a waiting area located near service location 13, such a display monitor could be provided in any customer waiting area. The monitor may be continuously logged-on to the server, or may be temporarily logged on via username and password each morning, or refresh cycle. Display monitor 23 constantly displays vehicle status for all vehicles serviced at service station 13, until the vehicle is delivered back to the customer; the fact of such delivery is communicated to the server by the Service Advisor as a status update. A customer, or “first user”, receives status updates by periodically viewing display monitor 23. In the preferred embodiment, display monitor 23 refreshes every minute to update service status. Referring to FIG. 1, the customer also has the option of receiving updates via text messages to the customer's mobile phone 21, or by email at customer's computer 22. This selection of secondary notification can be exercised at the outset of service when the Service Advisor initially meets with the customer and enters the customer record, or the Service Advisor can select this option later by adding a phone number or email address through an update.

As used herein the term “text message” is intended to include a message of purely textual format, HTML, any design or logo, audio or video message, email, or any communication that is meant to apprise the user of the status of service. As used herein, terms “mobile telecommunications device” or “mobile device”, “wireless device” or “wireless communication device” are intended to include a cellular telephone, a personal digital assistant, a laptop or the like, as well as any terminal that is coupled to a computer network and/or Internet that is capable of receiving text messages, audio messages, or video messages.

Referring to FIGS. 1 and 2, a Service Advisor starts the service at step 30. As the Service Advisor discusses the vehicle with the customer, the Service Advisor uses computer terminal 12 to link to remote server 20 over a computer network, e.g. the Internet. Remote server 20 may be any computer operating a central processing unit and coupled to the network. Computer terminal 12 serves as an input terminal and initially prompts the Service Advisor to log-on with a log-on screen. The Service Advisor enters his/her user-specific name and password to log into the software program running on the remote server 20. The software program uses the specific username for purposes of tagging those entries made while Service Advisor is logged into the system. Particular user privileges can be accessed via a personal user identification code and password. Other user privileges may be granted for Service Advisor(s) and Administrators (e.g., a service department manager, computer administrator, etc.).

If desired, the server can be configured to permit customers to login to view a duplicate screen of what is ordinarily displayed on the display monitor in the waiting area. When a customer logs into the system, the corresponding display indicates the particular service data associated with that customer. User identification data may include personal information, and may also include user specific log-on credentials.

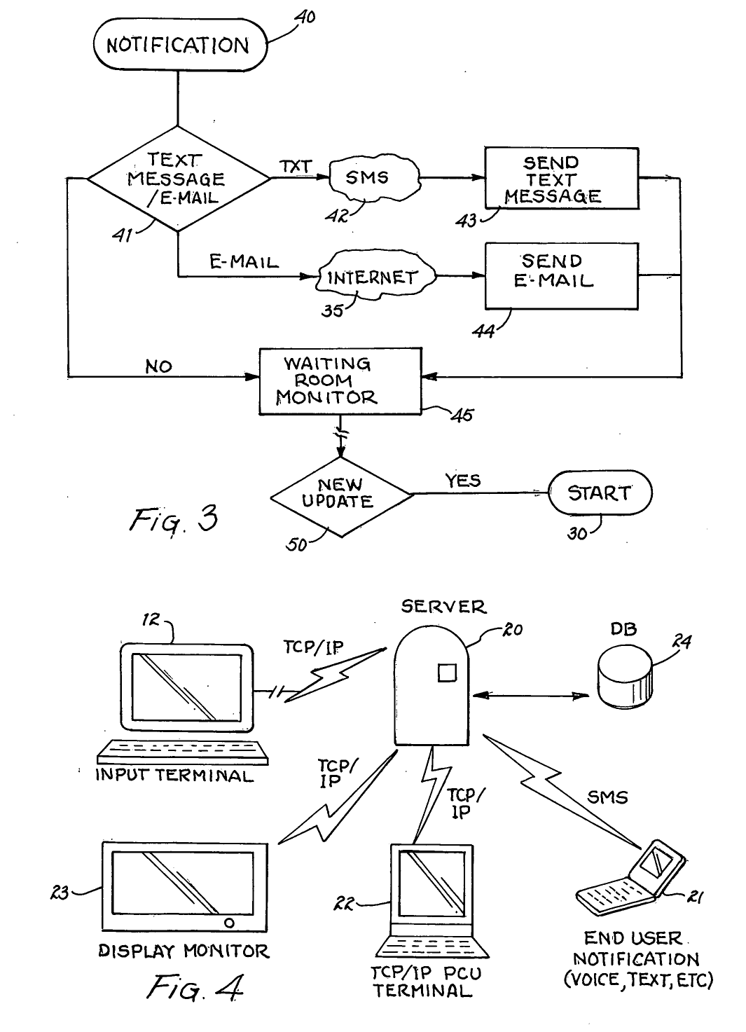

Turning briefly to FIG. 3, the Service Advisor can optionally select various modes to notify the customer regarding expected completion time. At step 41, the Service Advisor can enter a mobile telephone number to facilitate message notification by means of short message service (SMS) delivery 42 to a mobile communications device 43. The Service Advisor may, in the alternative, enter an email address to facilitate message notification via email 44. As indicated by step 45 of FIG. 3, the Service Advisor may also leave the secondary notification options blank, to rely solely on the waiting room display monitor 23 (See FIG. 1). If the customer requests notification by one of the secondary methods, the Service Advisor may set up appropriate triggers for notification to the customer that the service is underway; service status updates; that service has been completed; that the vehicle is ready for pick-up; or other status information that may be beneficial to the customer.

Returning to step 31 in FIG. 2, the Service Advisor typically enters the customer's shorthand name, year of the vehicle, and the make and model of the vehicle. The Service Advisor may also enter a second name (possibly the customer's last name or initial(s)) of the customer and further information about the vehicle, such as a vehicle identification number. If the Service Advisor inputs a full last name as the second name for the customer, the display will only indicate the first initial of the second name, in order to maintain privacy of customer identity. At step 32, the Service Advisor submits customer information to the server to create a new record. Next, at step 33, the Service Advisor enters service data that should include service requirements, each service requirement being associated with a certain time required for completion. After the Service Advisor completes such entries, step 34 allows the Service Advisor the option of editing the customer information, adding or changing services, adding extra time for service based on special circumstances, adding remarks, or making any other changes that will affect services or time to service. The total time for service and expected service time are then computed by the server. These computed values can then be transmitted by the server over the network to the primary display monitor and/or a secondary notification at a customer's mobile device. While still logged-on through the input terminal, the Service Advisor may also review the entire queue of pending customers associated with that Service Advisor. A Service Department Manager may review the entire queue of pending customers in the system.

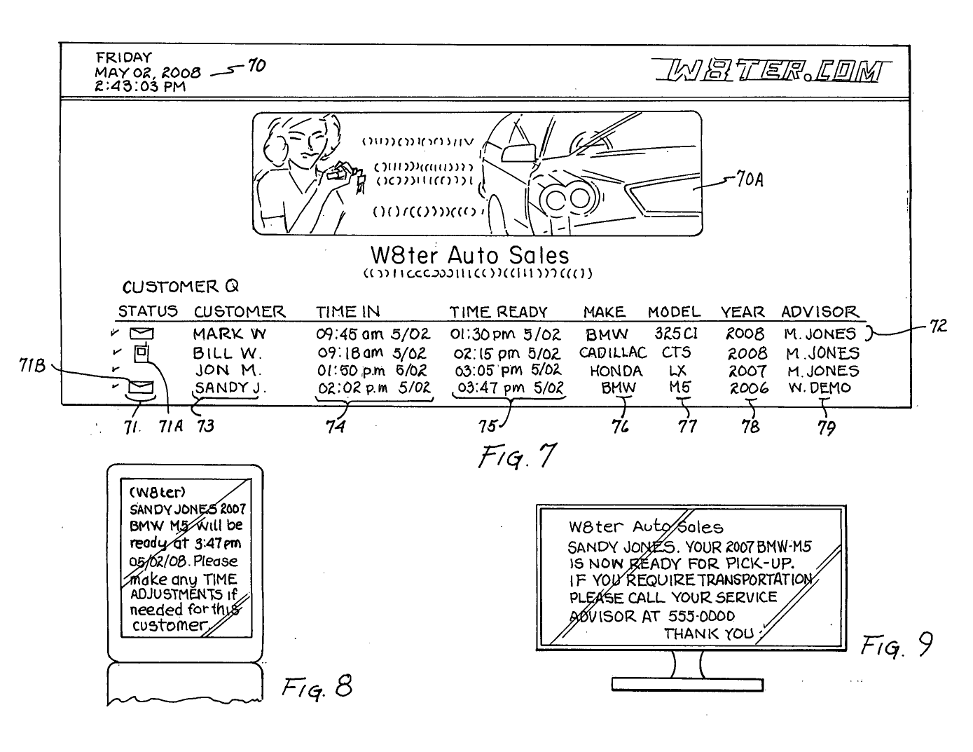

FIG. 3 demonstrates the logic flow upon detection of an occurrence that calls for a notification or an update of the display. Service updates include any changes to service that affect the type of service or expected completion time. When the Service Advisor inputs a new customer or new service data the notification process is initiated. Upon any trigger, such as service initiated, twenty minutes until expected service completion, vehicle ready for pickup, or similar set triggers, notification program 40 is initiated. In addition to the primary notification by way of display on the display monitor, the server may send a secondary notification by way of a notification to a mobile device or customer computer. The server will either send a secondary notification via SMS 42 to a mobile telecommunications device 43 or send a secondary notification via email 35 to an email delivery service to a terminal on the network 44. The server may also send no secondary notification. As technology permits, other secondary notification methods are herein contemplated. The server sends an updated status (see FIG. 7) to display on display monitor 23 (see FIG. 1). Display monitor 23 is updated with the new status of all vehicles. The same display is accessible by an authorized employee through any input terminal connected to the server, including a mobile telecommunications device capable of sending and receiving data packets. The term “terminals”, as used in this disclosure, includes mobile devices capable of receiving messages, displaying status, logging into the server and/or making service status updates.

As a Service Advisor or Service Department Manager enters status updates, steps 36, 37, 38 and 40 of FIG. 2 will be repeated, triggering a notification as outlined in FIG. 3.

An example of a common text-only notification at the outset of service of a vehicle might include the message: “Thank you (customer name) for selecting (service station/franchise) for your car care needs. Your (Year/Make/Model) will be ready at (Time) (Date).” When the current time is within the twenty, or thirty, minute time buffer zone (the buffer zone can be set to any time value specified) prior to computed pick-up time for a particular customer, display monitor 23 is updated, and that particular customer's name will turn green in the display monitor with an arrow pointing to the customer's service line. A Text Message, or other notification, is also sent to the Service Advisor to inform them that the customer's car will be ready soon, and to advise the Service Advisor to make any adjustments as needed.

Referring to FIG. 8, a common text message sent to a Service Advisor might read: “(Customer Name) (Year/Make/Model) will be ready at (Time/Date). Please make any TIME ADJUSTMENTS if needed for this customer.” Once the vehicle, or other customer service, is ready, display monitor 23 is again updated, and customer name will change to red in the display monitor with a check-mark next to customer's service line in the display. A text message may be sent to the customer. Referring to FIG. 9, such a text might read: “(Customer name), your (Year/Make/Model) is now ready for pick-up. If you require transportation, please call (Service Advisor name) at (phone number). Thank you.”

A follow-up may be scheduled with the customer. The follow-up may take the form of an automated text message that might read: “Thank you for using the (service station/franchise) on (Date). If you were not COMPLETELY SATISFIED with our service, please call (Service Advisor) at (phone number).”

FIG. 4 is a schematic view of the various components that are used to input and receive data related to customer service. Primary input terminal 12 is located at service location 13. However, in the preferred embodiment, server 20 is accessible by a Service Advisor via the Internet, allowing a Service Advisor to communicate with server 20 from any location where it is possible to access the Internet. Alternative input terminals have been described above and include, but are not limited to, any terminal with access to the Internet, such as a personal computer, a server terminal, a mobile telecommunications device, PDA, or any other electronic device capable of uploading information to server 20. Server 20 accesses database 24 to store and retrieve customer data, customer service data, status data, and other information. Server 20 uses this information to determine total service time and expected time of completion.

In the preferred embodiment, server 20 sends messages via TCP/IP to terminal 22. Terminal 22 could be a spare terminal at service location 13, perhaps located within garage 10, alternatively terminal 22 could represent an off-site computer, for example, a customer's personal computer which connects to remote server 20 over the Internet. Alternatively, server 20 may communicate, e.g. over the Internet, to an SMS server to relay messages to mobile device 21. By way of example, CellTrust Corporation of Scottsdale, Ariz. offers SMS messaging services. A text message can be relayed over the Internet to CellTrust Corporation, along with the telephone number of the cell phone to which such text message is being sent. A CellTrust Corporation SMS server then interfaces with a cellular telephone network for issuing the requested text message to the designated cell phone. Display monitor 23 can be either a dummy terminal, with a constant/periodic connection to the network, or a smart terminal that allows a user to input log-in credentials.

An administrator of service location 13 assigns each Service Advisor a unique set of log-in credentials that include a Username and password. An example password might be “yourname@dealership.com” and the password may be any ASCII character combination, or other secure password as deemed appropriate by the administrator. Each set of log-in credentials will allow the system to identify the relevant Service Advisor who enters data for each customer/vehicle.

FIG. 5 shows the process of adding a new customer record. At step 52, the Service Advisor first logs into the system with the necessary credentials. At step 53, the Service Advisor will choose necessary service details from a check-list. The check-list contains various service categories related to type of service and service packages and is displayed on a service sheet. Adjacent to each such listing is a suggested time allotment for the particular service. Once the necessary boxes are selected, the data entered by the Service Advisor is sent to the server. At step 55, the server calculates the total service time needed for the services selected. Time adjustments may be made through a drop down menu. In the preferred embodiment, the input terminal runs a software program, such as a java applet, that adds the predicted service time in real-time to allow for the Service Advisor to note the cumulative time as each box is checked.

The Service Advisors checks the availability and capacity of service to make any necessary time adjustments (step 54). Once server 20 calculates total time required for service (step 55). At step 56, server 20 makes any necessary time adjustments to the total service time to compute a projected end of service time. Once the projected end of service time is computed, at step 59, expected total service time and end of service time will be stored in database 24. Database 24 may also store information for subsequent data mining purposes. The information can then be used to update the display on the display monitor and/or the terminal (step 58). At step 57, various triggers are set to apprise the customer of service status. Triggers set at step 57 may include a notice of when the vehicle is set for service in a service bay; a notice that there is a twenty minute lead time before expected completion; a notice that service is complete; a notice that the vehicle is ready for pick-up; a notice that the vehicle is waiting a set amount of time after service; or any other reasonable message to apprise the customer of service status as set by the Service Advisor, Service Department Manager or requested by the customer.

Once the computations are made by server 20 updated service status is displayed on input terminal 12, as per step 58. Referring to FIG. 7, a new customer line is created on the screen of display monitor 23. Row 72 indicates, in successive columns, customer name 73, time in for service 74, expected end (ready) time 75, additional information on the vehicle (make 76, model 77, year 78, etc.), and Service Advisor assigned 79 to the customer. Display monitor 23 displays date and time 70 to help customers gain perspective on service and end times, and may display a promotional message or advertisement 70A. A promotional message is any message, or notification, containing information that is not directly associated with immediate services already scheduled. Next to each customer name (row) 73, an icon may appear to designate whether or not the customer is set to receive secondary notification by way of text messages, emails, or any other notification mentioned above. The icon will be displayed in status column 71, a cell-phone icon 71A designates that the customer is set to receive text messages via a mobile device, and an envelope 71B designates that such notifications will be sent via email.

Customer record row 72 will be color coded to help further identify status in the queue. When the service is expected to be completed within twenty minutes (or other set time), row 72 will take on a new color (e.g., green) to demonstrate this status. Once the service is complete and the vehicle is ready for pick-up (or service rendered), row 72 takes on a new color (e.g., red) to alert the customer of completed service. In the preferred embodiment, a customer's name is highlighted in blue to designate that the vehicle is waiting for service, or that there is more than twenty minutes needed to complete service. A green color will designate expected completion within a twenty minute window. A red color will designate that the vehicle is ready for pick-up and service is complete.

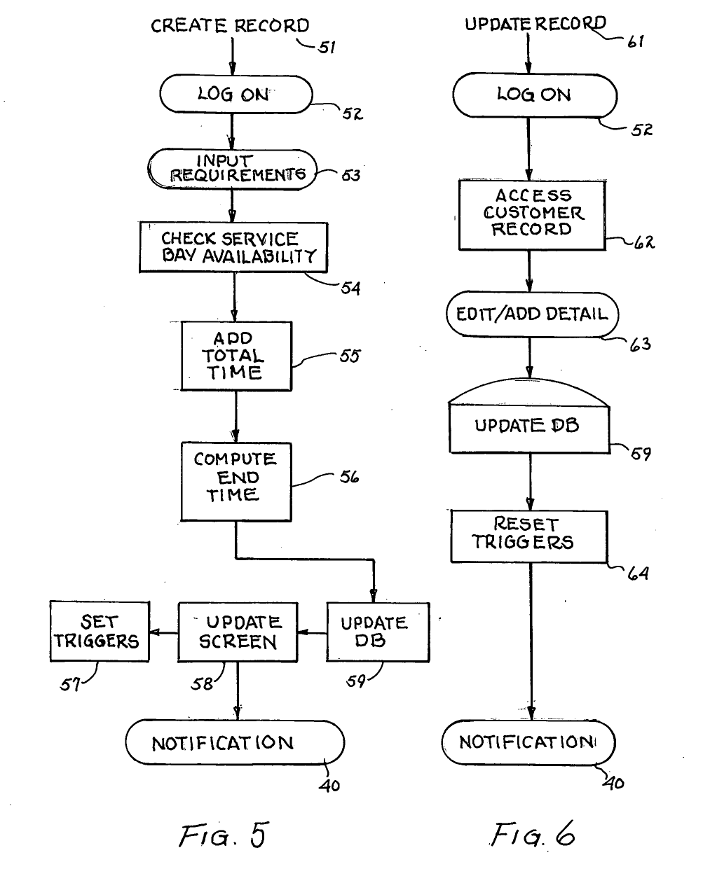

Referring to FIG. 6, any addendum or change to service will require logging into the system. At step 52, the Service Advisor provides access credentials, a username and password, to access those records associated with that Service Advisor. In an alternate embodiment, a Service Advisor can access all customer records, at step 62. The same service selection screen will appear to the Service Advisor, with service items previously selected appearing with an “already checked” status. At step 63, the Service Advisor may then add, edit, or delete service requirements, change the special circumstances, add/edit further delays, or make any changes that were available at the outset of creating a customer record. At step 59, the service time and end time are recalculated, and the database is updated. At step 64, any triggers and alerts will be reset accordingly. Notification 40 is sent to any secondary device selected to indicate the edits to service.

The application of this queuing system is contemplated for other service industries. While the preferred embodiment is use of this system and method in a car repair shop, those skilled in the art will anticipate such method and system is useful in other service industries where customers are required to queue and wait for services.

Those skilled in the art will now appreciate that a system and method have been described to provide an automated service status update system and related method for keeping customers apprised of the status of requested service. The system provides customers with multiple options to receive service status updates, prompt notice when the requested service is nearing completion, and allows customers to feel more at ease while waiting for the requested service to be completed. The system and method allows customers to roam from the service location to make better use of their time while awaiting completion of the requested service. The system and method allows service providers to work with less interruption from impatient customers and frees service personnel to leave the service location while still remotely connected to the system to perform status updates. The system also permits automatic follow-up with customers to ensure their satisfaction, and to allow the service providers to obtain customer feedback.

While the present invention has been described with respect to a preferred embodiment thereof, such description is for illustrative purposes only, and is not to be construed as limiting the scope of the invention. Various modifications and changes may be made to the described embodiments to conform with various service industries to which those skilled in the art will appreciate, and such modifications would not depart from the true spirit and scope of the invention as defined by the appended claims.

1. A system for communicating information regarding service queue status to at least first and second users, said system comprising:
a) a first input terminal disposed at a service location coupled to a computer network for entering customer service data.
b) a server coupled to the computer network and including a database, said server receiving the customer service data, said server computing service completion status data;
c) a display monitor disposed proximate to said service location, said display monitor being coupled to the computer network and responsive to said server for displaying the service completion status data for viewing by said first user;
d) at least one wireless device allowing said second user to receive a message from a telecommunications network; and
e) said server being coupled to the telecommunications network for sending a message to said wireless device to display service completion status data for viewing by said second user.

2. The system of claim 1 wherein said first input terminal is adapted to enter service updates, said server receiving the service updates, for re-computing the service completion status data.

3. The system of claim 1 wherein said service status data indicates a projected time of completion of a service, and wherein said server is programmed to detect the projected time of completion of such service within a predetermined period of time, and said server programmed to generate a trigger signal in response thereto.

4. The system of claim 3 wherein the display monitor is responsive to the trigger signal for altering the service completion status data displayed by said display monitor.

5. The system of claim 3 wherein, in response to said trigger signal, said server sends a message to said wireless device.

6. The system of claim 1 wherein the computer network is operably coupled to a global computer network.

7. The system of claim 1, including a second input terminal coupled to said computer network for entering customer service data.

8. The system of claim 7, wherein said second input terminal comprises a wireless communications device.

9. The system of claim 8 wherein said wireless communications device includes a display screen to display service completion status data.

10. A method for tracking and communicating information regarding service queue status for services offered at a service location, said method comprising the steps of:
a) inputting customer service data into an input terminal, the input terminal coupled to a computer network;
b) transmitting the customer service data over the computer network to a server;
c) using the server to compute service completion status data;
d) providing a display monitor proximate to the service location for viewing by at least a first user;
e) transmitting service completion status data from the server to the display monitor via the computer network; and
f) displaying service completion status data upon the display monitor to at least the first user.

11. The method recited by claim 10 wherein the server performs the further steps of:
g) generating a text message to provide a second user with service completion status data; and
h) causing said text message to be sent to the second user's mobile telecommunications device for viewing by said second user.

12. The method recited by claim 10 wherein said service status data indicates a projected time of completion of a service, and including the steps of:
g) detecting the projected time of completion of such service; and
h) generating a trigger signal in response thereto.

13. The method recited by claim 12 including the step of altering the service completion status data displayed by said display monitor in response to the trigger signal.

14. The method recited by claim 12 including the step of sending a message to said wireless device in response to said trigger signal.

15. The method recited by claim 10, further comprising the step of sending a notification of completed service to the mobile telecommunications device.

16. The method of claim 10, wherein the step of transmitting customer service data includes the step of transmitting customer data and service status data.

17. The method recited by claim 16 wherein the computer network is operably coupled to a global computer network.

18. The method recited by claim 17 wherein the customer service data includes user identification data.

19. The method recited by claim 10 wherein the step of inputting customer service data includes the step of using a wireless communications device as an input terminal.

20. The method recited by claim 11, wherein the message includes a promotional message that may be displayed on the mobile telecommunications device.

21. The method recited by claim 10, wherein the display monitor displays a promotional message.

22. The method recited by 10 including the steps of:
g) inputting service update data to adjust service time;
h) communicating service update data to the server;
i) re-computing a renewed service time; and
j) transmitting the renewed service time to the display monitor for viewing by said first user.

23. The method recited by 22 wherein said renewed service time is communicated to a mobile telecommunications device for viewing by said second user.

24. A method for tracking and communicating information regarding service queue status to at least a first user, said method comprising the steps of:
a) inputting customer data into an input terminal, the input terminal coupled to a computer network and the input terminal disposed at a service location;
b) transmitting the customer data from the input terminal to a server over the computer network;
c) computing a projected end time;
d) displaying the projected end time on a display monitor, the display monitor located proximate to the service location for viewing by said first user;
e) detecting the projected end time;
f) generating a trigger signal in response to the projected end time; and
g) altering display on the display monitor in response to the trigger signal.

25. The method recited by claim 24 including the step of sending a message to a wireless device in response to said trigger signal.

26. The method as recited by claim 24 further including the steps of:
h) inputting service update data to adjust service time;
i) communicating service update data to the server;
j) re-computing a renewed service time; and
k) transmitting the renewed service time to the display monitor for viewing by said first user.

27. The method as recited by claim 24 wherein the server performs the further steps of:
g) generating a text message to provide a second user with service completion status data; and
h) causing said text message to be sent to the second user's mobile telecommunications device for viewing by said second user.

28. The method as recited by claim 24 further including the step of sending a follow-up message to the first user.

29. The method as recited by claim 27 further including the step of sending a follow-up message to at least one of said first and second users.
